(19) United States
(12) Patent Application Publication
(10) Pub. No.: US 2002/0023548 A1
(43) Pub. Date: Feb. 28, 2002

(54) Holey foil

(76) Inventor: Jose Mario Almeida, Miami, FL (US)

Correspondence Address: Jose Mario Almeida, 12221 SW 99 St, Miami, FL, 33186, US

(21) Appl. No.: 09/919,031

(22) Filed: Jul. 31, 2001

Related U.S. Application Data
(60) Provisional application No. 60/223,258, filed on Aug. 3, 2000.

(51) Int. Cl. A47J 9/00

(52) U.S. Cl. 99/450

(57) ABSTRACT

A holey foil 1 comprises a sheet of aluminum foil presenting multiple small perforations 2 distributed throughout most of the surface, cut to standardized sizes and enclosed in a package 3 or provided in a roll 4 for easy dispensing.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

The present invention relates to cooking. The present invention is particularly useful in barbecuing and frying. Barbecuing and grilling are sometimes cumbersome when cooking greasy foods such as hamburgers. The grease from the food drips through the grill and causes the flames below to grow out of control. Grease and food stick to the grill requiring cleanup afterward. Frying causes grease spattering and the resulting cleanup problem.

In the case of frying, a device which has been used to prevent spattering consists of a fine metallic mesh placed on a circular metal frame with a handle. This device is used as a lid on the frying vessel to allow vapors to freely escape while minimizing spattering. The metallic mesh is difficult to clean afterwards and the device must be stored for subsequent uses. It is an object of the present invention to provide the same utility of the device just described, while eliminating the disadvantages of cleanup and storage.

In the case of barbecuing and grilling, one of the expected benefits of this manner of cooking is reduction of grease in the cooked product, another expected benefit is flavoring provided by vapors from the fire fueling elements, such as selected wood chips and charcoal blocks. Placing the meat cuts and other food portions directly on the grill results in uncontrolled dripping of large blobs of grease causing flare-ups, occasional burned cooking, or needing emergency placating of the flames with beer or water. Also, direct placement of the food on the grill causes accumulation of carbon residue from burned grease and food particles.

The present invention provides controlled dripping of grease through small perforations on the foil to reduce flare-ups, protects the food from direct flames in case of even small flare-ups, allows flavoring through the perforations, and reduces the cleanup problem.

### BRIEF SUMMARY OF THE INVENTION

According to the present invention, there is provided a holey foil which comprises a sheet of aluminum foil with multiple perforations evenly distributed throughout most of its surface. The holey foil may be rectangular or circular in shape and of dimensions suitable for covering a major portion of a barbecue grill, or completely covering a frying pan. The dimensions of the sheet may range from 24 cm to 36 cm on a side for rectangular sheets, and the same range in diameter for circular sheets. The sheets may be cut in standard sizes for convenient packaging in stacks, or provided in rolls for easy dispensing to varying lengths.

Further, the perforations may be of different sizes for different uses. Holey foils provided with very small perforations would be more suited for minimizing spattering in flying, while foils provided with larger perforations would be more suited for using on the barbecue grill.

### BRIEF DESCRIPTION OF THE DRAWINGS

The invention will now be described in more detail, by way of example, with reference to the accompanying drawings.

In the drawings:

FIG. 1A illustrates a sheet of holey foil 1 with relatively large perforations 2.

FIG. 1B illustrates a sheet of holey foil 1 with relatively small perforations 2.

FIG. 2 is a side view of a pictorial view of a pack 3 (shown dotted) of holey foil sheets 1 cut to a standard size and stacked for easy storage and dispensing.

FIG. 3 is a side view of a pictorial view of a roll of holey foil 4 for easy dispensing to a length of choice by the user.

FIG. 4 illustrates one use of a holey foil 1 in cooking hamburgers 7 on a grill 5.

FIG. 5 illustrates one use of a sheet of holey foil 1 (shown transparent) in covering a frying pan 6.

### DETAILED DESCRIPTION OF THE INVENTION

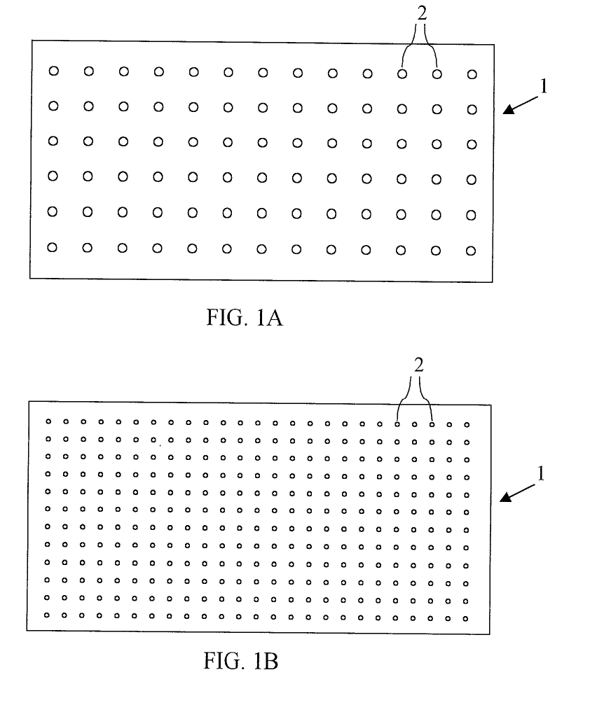

Referring first to FIG. 1A reference numeral 1 indicates a sheet of aluminum foil with relatively large perforations 2. FIG. 1B illustrates a sheet with relatively small perforations using the same reference numerals, respectively.

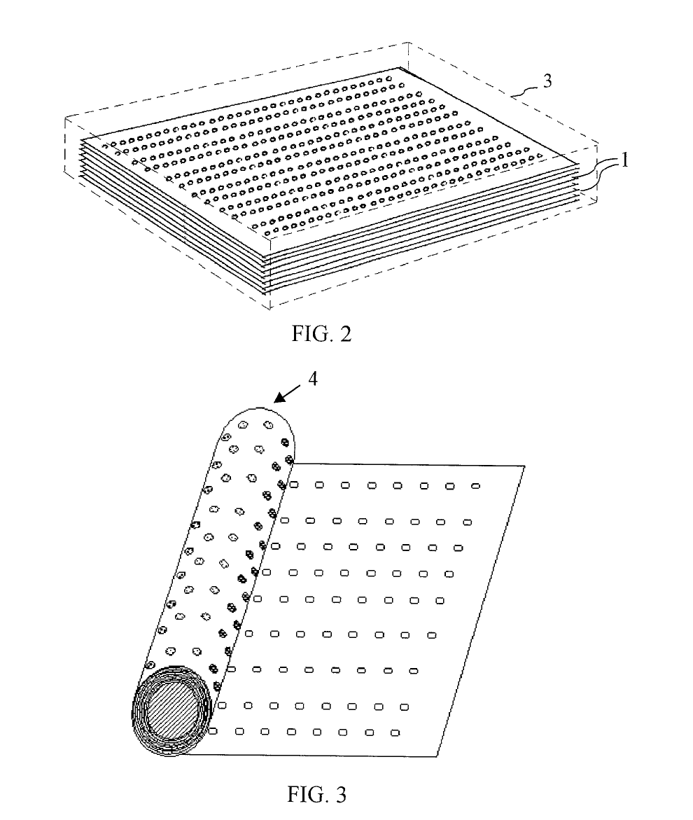

Referring to FIG. 2 the holey foils 1 would be cut in standard sizes, such as to provide ample cover for standard size cooking vessels. For example, the following sizes could be established:

Small: 24 cm×24 cm or 24 cm in diameter

Medium: 30 cm×30 cm or 30 cm in diameter

Large: 36 cm×36 cm or 36 cm in diameter

Perforations may be different for different uses. The size of a perforation and the number of perforations per unit area may be varied. It is recognized that small perforations, under 4 mm², would be more convenient for prevention of liquid spattering in frying, simmering, boiling and the like. Larger perforations, 4 mm² and greater, would be best suited for grilling and barbecuing. It is also recognized that smaller perforations allow larger density of perforations per unit area. Total area of perforations should be between 5 and 10% of total foil area to avoid compromising integrity in tearing and handling.

Further, these foil sheets would be stacked and packaged in a cardboard container 3 according to area and size of perforation for easy storage and dispensing.

When used in barbecuing, a holey foil is placed directly on the grill with meat cuts or other food portions placed on top of the holey foil.

When used for covering a cooking vessel in frying, simmering, or boiling, a holey foil would normally be folded down around the edge of the vessel to prevent it from shifting.

Referring to FIG. 3, the holey foil would also be provided in rolls 4 of standard lengths and widths in a manner similar to the way regular aluminum foil for kitchen use is now distributed.

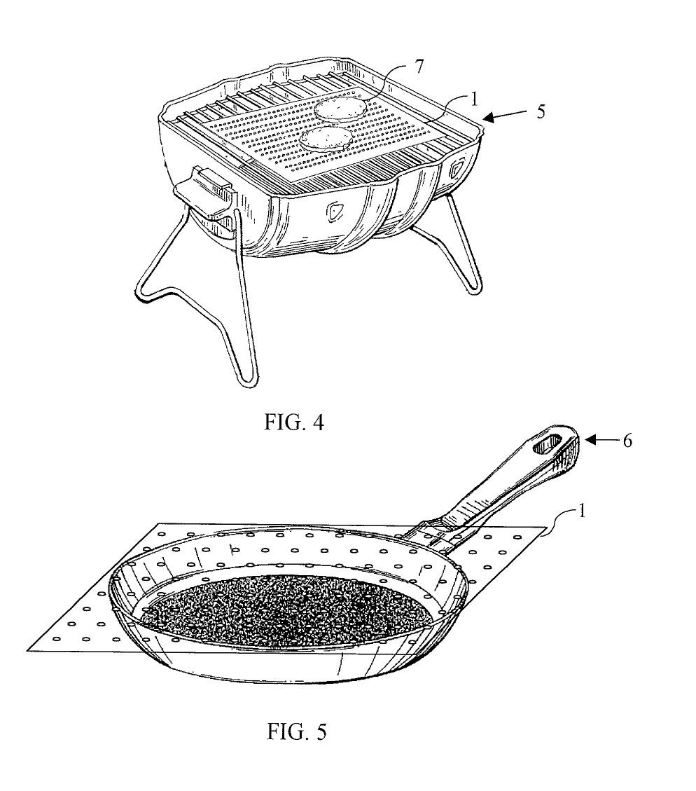

FIG. 4 depicts a representation of the method of grilling according to the invention. A major difficulty with cooking hamburgers directly on the grill, is that large blobs of grease drip though the grill causing flare ups. Using a holey foil 1, the grease flows through many different holes in smaller drops, reducing flare-ups.

Since the holey foil reduces the area of the food that is exposed to the flames, the food is further protected from being burnt.

FIG. 5 depicts the use of the holey foil 1 to cover a frying pan 6. When frying and when simmering to prepare sauces or condiment mixtures, a common problem is spattering of grease and sauce outside the cooking vessel. Using a solid lid is inadequate because it is desirable to let water vapor escape freely for proper frying without the effect of boiling, and for proper consistency of sauces and condiment mixtures. Covering the frying pan with holey foil of small perforations provides suitable shield for spattering, while allowing vapors out. The foil is later disposable (recyclable) and cleanup is easier.

I claim:

1. A sheet of holey foil which comprises a sheet of aluminum foil with relatively small perforations distributed throughout most of its surface.

2. A pack which comprises a stack of sheets of holey foil as claimed in claim 1, wherein the sheets of holey foil are stacked one on top of the other and enclosed in a container.

3. A roll which comprises a long sheet of holey foil as claimed in claim 1, wherein the sheet of holey foil has been rolled.
